(19) United States
(12) Patent Application Publication
(10) Pub. No.: US 2011/0276978 A1
(43) Pub. Date: Nov. 10, 2011

(54) System and Method for Dynamic CPU Reservation

(76) Inventors: Andrew Gaiarsa, Ontario (CA); Roger Keith Wiles, Corinth, TX (US)

(21) Appl. No.: 12/776,573

(22) Filed: May 10, 2010

(51) Int. Cl. G06F 9/46

(52) U.S. Cl. 718/104

(57) ABSTRACT

A computer readable storage medium storing a set of instructions executable by a processor. The set of instructions is operable to receive an instruction to reserve a processor of a system including a plurality of processors, receive an instruction to perform a task, determine whether the task has affinity for the reserved processor, execute the task using the reserved processor if the task has affinity for the reserved processor, execute the task using one of the processors other than the reserved processor if the task does not have affinity for the reserved processor.

### BACKGROUND

Computing systems having multiple CPUs may allow tasks to be allocated to specific CPUs in various manners. Users of such systems may wish to reserve a CPU for a certain set of tasks that may be allocated to the reserved CPU. This may enable certain tasks to be treated preferentially and thus provide better performance for those tasks. It may be further advantageous for a user to be able to accomplish such a reservation at runtime.

### SUMMARY OF THE INVENTION

A computer readable storage medium stores a set of instructions executable by a processor. The set of instructions being operable to receive an instruction to reserve a processor of a system including a plurality of processors; receive an instruction to perform a task; determine whether the task has affinity for the reserved processor; execute the task using the reserved processor, if the task has affinity for the reserved processor; and execute the task using one of the processors other than the reserved processor, if the task does not have affinity for the reserved processor.

A system includes a memory, a plurality of processors, and a task scheduler. The task scheduler maintains a global variable storing a reservation status of each of the processors. The task scheduler receives an instruction to reserve a selected one of the processors and modifies the global variable to indicate that the selected processor is reserved. The task scheduler allocates to the selected processor only tasks having affinity for the selected processor while the selected processor is reserved.

A method includes receiving an instruction to reserve a processor of a system including a plurality of processors; receiving an instruction to perform a task; determining whether the task has affinity for the reserved processor; executing the task using the reserved processor, if the task has affinity for the reserved processor; and executing the task using one of the processors other than the reserved processor, if the task does not have affinity for the reserved processor.

### BRIEF DESCRIPTION OF THE DRAWINGS

FIG. 1 shows an exemplary multi-processor system.

FIG. 2 shows a method for reserving and un-reserving processors of a multi-processor system, such as the system of FIG. 1, according to an exemplary embodiment.

### DETAILED DESCRIPTION

The exemplary embodiments of the present invention may be further understood with reference to the following description and the appended drawings, wherein like elements are referred to with the same reference numerals. The exemplary embodiments describe systems and methods for providing dynamic CPU reservation capability.

Operating systems executed by multi-processor computing systems, such as symmetric multiprocessing (“SMP”) systems, may provide (e.g., to a software developer, to an end user, etc.) the ability to assign certain tasks to a specific CPU. This may be referred to as “task CPU affinity”. A task scheduler of such operating systems may then ensure that only the specified CPU executes tasks that have affinity for that particular CPU. While task scheduling algorithms allow any task to be run on any CPU (e.g., default SMP operation), in some situations it may be desirable to assign a specified set of tasks to a specified CPU. For example, in some situations, the specified CPU may have a particular resource or capability that may make it well-suited to handling the specified set of tasks.

Thus, through “CPU reservation”, specific CPUs can be “reserved” to only execute tasks that have CPU affinity for the specific CPUs. Reservation of a CPU to exclusively execute tasks that have CPU affinity for the CPU may prevent dedicated tasks from being preempted by other tasks in the system, and thus the performance of such tasks may be improved. In one example, networking-related tasks may be sent to a dedicated CPU operating under a run-to-completion model in order to achieve faster response times for such tasks. Other potential applications that may benefit from a reserved CPU may include compression or decompression of data, control of an instrument that folds molecules for scientific research, graphics processing, decryption of encrypted data, processing data using a pattern matching algorithm, conversion of data from one format to another, sampling a sensor of a medical device in real time, processing firewall rules for packet data, high-speed data filtering, etc.

CPU reservation mechanisms may be either static or dynamic in nature. A static CPU reservation mechanism may only support the specification of a CPU, or a set of CPUs, for reservation at compile time, such as through the use of a configuration macro. In contrast, the exemplary embodiments present a dynamic mechanism for CPU reservation, by which CPUs may be reserved and unreserved for certain tasks at runtime.

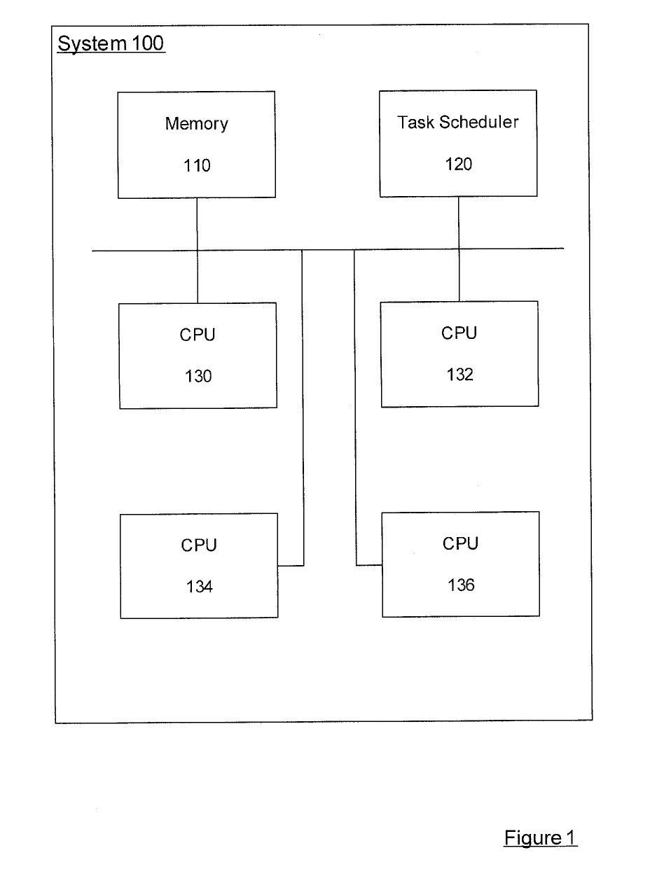

FIG. 1 illustrates an exemplary multi-processor system 100 which may operate in accordance with the exemplary methods described below. The system 100 includes a memory 110 and a task scheduler 120, which may be a component of an operating system and may allocate tasks to the CPUs. The system 100 also includes CPUs 130, 132, 134 and 136. The CPU hardware of each of the CPUs 130, 132, 134 and 136 may be identical or may differ. The elements of the system 100 may be connected by a bus 140; however, those of skill in the art will understand that this is only exemplary, and that in other systems, the connection between elements may be accomplished in a different manner. For example, in a distributed computing system, elements may be connected by various network hardware. The system 100 may also include input/output elements to provide user access, network hardware, etc., not shown in FIG. 1. In one embodiment, the CPUs 130, 132, 134 and 136 may be linked together via a wireless network and may interact via wireless networking hardware and wireless protocols that may allow one CPU to reserve and start threads on remote CPUs.

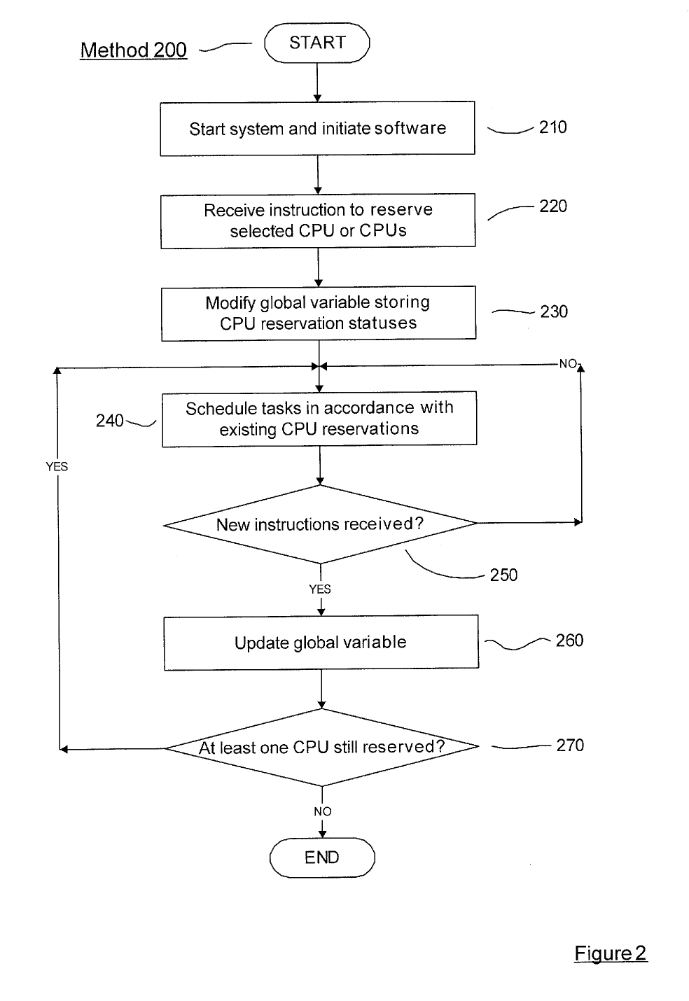

FIG. 2 illustrates an exemplary method 200 for dynamic CPU reservation. The method 200 may be performed, for example, by the task scheduler 120 of FIG. 1, and will be described with reference to the system 100 of FIG. 1. In step 210, the system 100 is booted and various software programs are initiated in accordance with the needs of a user of the system. In step 220, the task scheduler 120 receives an instruction to reserve one or more of the CPUs 130, 132, 134 and 136. For illustrative purposes, it will be assumed that the task scheduler 120 has received an instruction to reserve CPU 130 for tasks with affinity for CPU 130. The instruction may be generated, for example, directly by a user, by an instruction within a program being executed by the system 100, etc. In one embodiment, the instruction may take the form of code that will be illustrated below.

In step 230, the task scheduler 120 modifies a global variable (e.g., a variable common to all the CPUs 130, 132, 134 and 136) that describes the current reserved/not-reserved state of all the CPUs 130, 132, 134 and 136. The global variable may be a multi-bit field in which each bit represents the reservation state of one of the CPUs, and its global nature may ensure that each CPU may accurately see, in one place, the same current reservation state for each of the other CPUs. In step 240, the task scheduler schedules the performance of various tasks relating to programs being executed on the system 100 in accordance with the global variable governing the reservation status of the CPUs 130, 132, 134 and 136. That is to say, if CPU 130, for example, is reserved, then only tasks with CPU affinity for CPU 130 are scheduled to be performed by CPU 130. In contrast, the task scheduler 120 may schedule non-affinity tasks on non-reserved CPUs in accordance with another scheduling algorithm. As stated above, a task may be configured to have affinity for a specified CPU, for example, if a CPU has particular characteristics making it particularly suited to that task, to optimize the performance of a particular task or class of tasks, such as networking tasks, by providing a dedicated CPU for the tasks, etc.

In step 250, the task scheduler 120 determines whether it has received new instructions regarding reservation status of the CPUs 130, 132, 134 and 136. This may include unreserving a CPU (e.g., CPU 130) that has been previously reserved, or reserving one or more CPUs (e.g., CPU 132) that was previously unreserved. In one embodiment, this reservation instruction may be accomplished using code as described below. If no new instructions have been received, the method returns to step 240, and the task scheduler 120 continues scheduling tasks to run in accordance with the global reservation variable as previously defined. If new instructions are received, then in step 260 the task scheduler 120 updates the global variable (e.g., adds a new reservation, removes a previous reservation) in accordance with the instructions.

In step 270, the task scheduler 120 determines whether the global variable still indicates that at least one CPU remains reserved for tasks with affinity for that CPU. (In contrast, the instruction received in step 250 may have unreserved all CPUs that were previously reserved, leaving no reserved CPUs remaining.) If one or more CPUs are still reserved, the method returns to 240, and the task scheduler continues scheduling tasks to run in accordance with the global reservation variable as previously defined. If no reserved CPUs remain, the method 200 terminates.

In one implementation, the exemplary embodiments may be supported by a set of application programming interfaces (“APIs”). A first API provides a user with the current set of reserved CPUs in the returned cpuset_t.

STATUS CpuReservedGet(cpuset_t*pCpuSet)

A second API attempts to reserve the CPU or CPUs specified in <cpus> and returns the identity of the CPU or CPUs reserved as a result of the attempt in <pReserveCpus>. All tasks without CPU affinity for the reserved CPUs are subsequently prevented from executing on the reserved CPUs, as described above. Here and elsewhere in the present disclosure, comments within code will be indicated /*thusly*/.

| | |
|---|---|
| STATUS CpuReserve | |
| ( | |
| cpuset_t cpus | /*CPUs to be reserved*/ |
| cpuset_t *pReservedCpus | /*CPUs reserved*/ |
| ) | |

A third API unreserves a specified CPU or CPUs to resume regular scheduling as the scheduler sees fit. If more than one CPU is specified to be unreserved in <cpus>, the operation succeeds only if all unreservations are valid; otherwise, none of the specified CPUs are unreserved and an error is returned. An unreservation may be invalid, for example, if the unreservation request has specified a CPU that is not reserved. The following segment of code presents error cases in an unreservation API:

STATUS CpuUnreserve (cpuset_t cpus)
{
cpuset_t nextCPU;
if (CPUSET_ISZERO (cpus))

{
errnoSet (S_CpuLib_INVALID_ARGUMENT);
return ERROR;
}

if (!_WRS_CPU_IS_SUBSET (cpus, CpuSetReserved))

{
errnoSet (S_CpuLib_INVALID_ARGUMENT);
return ERROR;
}

/*Remainder of implementation (omitted) follows here*/
}

The CPU reservation may further be accomplished by means of a global (e.g., not per-CPU) variable describing the current state of which CPU or CPUs are reserved. In one implementation, this variable may be called “cpuset_t CpuSetReserved”. A task scheduler, such as the task scheduler 120 of FIG. 1, may examine the global variable when determining which READY tasks should be scheduled to execute, and, in accordance with the exemplary embodiments, may only make tasks with affinity to a particular CPU eligible for execution on that CPU if it is marked reserved.

In systems implementing the exemplary embodiments, a complication may arise that is not present in multi-processor systems incorporating static CPU reservation. Specifically, when a CPU reservation request is performed, a task that is currently executing on a CPU being reserved by the request must be examined to determine whether it has affinity for the CPU. If it does not, it must be scheduled to execute on another CPU. Further, if the currently executing task on the newly-reserved CPU has locked preemption, it is not immediately rescheduled, but, rather, is rescheduled when the task eventually performs a taskCpuUnlock( ).

The following presents code operable to reserve an arbitrary CPU and set the CPU affinity of a task to execute on the reserved CPU according to an exemplary embodiment:

void myRtn (void)

| | |
|---|---|
| { | |
| cpuset_t cpuSet; | /*Input argument to CpuReserve*/ |
| cpuset_t resCpuSet; | /*Output argument from |
| CpuReserve*/ | |

/*Passing an empty cpuset as input reserves an
arbitrary CPU*/
CPUSET_ZERO (cpuSet);
if (OK == CpuReserve (cpuSet, &resCpuSet))

{
/*Set affinity for current task*/
taskCpuAffinitySet (0, resCpuSet);
}

else

{
/*Handle error*/
}

}

The following presents code operable to reserve one or more specified CPUs and set CPU affinity for several tasks to execute on those specified CPUs according to an exemplary embodiment:

void myRtn (void)

| | |
|---|---|
| { | |
| extern int tids[3]; | /*Some task IDs*/ |
| int cpuIx[ ] = {1,2,4}; | /*CPU indices to reserve*/ |
| cpuset_t cpuSet; | |
| cpuset_t tmpCpuSet; | |
| int i; | |

/*Initialize cpuSet with desired CPU indices*/
CPUSET_ZERO (cpuSet);
CPUSET_SET (cpuSet, cpuIx[0]);
CPUSET_SET (cpuSet, cpuIx[1]);
CPUSET_SET (cpuSet, cpuIx[2]);
/*Reserve the specified CPUs*/
if (OK == CpuReserve (cpuSet, NULL))

{
for (i = 0; i < 3; i++)

{
tmpCpuSet = CPUSET_FIRST_SET (cpuSet);
taskCpuAffinitySet (tids[i], tmpCpuSet);
CPUSET_SUB (cpuSet, tmpCpuSet);
}

}

else

{
/*Handle error*/
}

}

The exemplary embodiments described above may allow CPUs to be reserved and unreserved dynamically at runtime. This may provide to users and software developers the ability to reserve CPUs for specific tasks when such reservation is desirable, while retaining the freedom to unreserve the CPUs and allow load balancing to occur in another manner, such as by default SMP operation.

Those skilled in the art will understand that the above-described exemplary embodiments may be implemented in any number of manners, including, as a separate software module, as a combination of hardware and software, etc. For example, the task scheduler 120 may be a program containing lines of code that, when compiled, may be executed by a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A computer readable storage medium storing a set of instructions executable by a processor, the set of instructions being operable to:
receive an instruction to reserve a processor of a system including a plurality of processors;
receive an instruction to perform a task;
determine whether the task has affinity for the reserved processor;
execute the task using the reserved processor, if the task has affinity for the reserved processor; and
execute the task using one of the processors other than the reserved processor, if the task does not have affinity for the reserved processor.

2. The computer readable storage medium of claim 1, wherein the system is a symmetric multiprocessing system.

3. The computer readable storage medium of claim 1, wherein the set of instructions is further operable to:
modify a global variable indicating that the reserved processor has been reserved.

4. The computer readable storage medium of claim 1, wherein the instruction is received at runtime.

5. The computer readable storage medium of claim 1, wherein the set of instructions is further operable to:
receive, at runtime, a further instruction to remove the reservation of the processor; and
execute a further task using the formerly reserved processor, after receiving the further instruction, regardless of whether the task has affinity for the reserved processor.

6. The computer readable storage medium of claim 5, wherein the further instruction is received at runtime.

7. The computer readable storage medium of claim 5, wherein the set of instructions is further operable to:
modify a global variable to indicate that the processor has been unreserved.

8. A system, comprising:
a memory;
a plurality of processors; and
a task scheduler maintaining a global variable storing a reservation status of each of the processors, the task scheduler receiving an instruction to reserve a selected one of the processors and modifying the global variable to indicate that the selected processor is reserved, the task scheduler allocating to the selected processor only tasks having affinity for the selected processor while the selected processor is reserved.

8. The system of claim 8, wherein the task scheduler receives the instruction at runtime.

9. The system of claim 8, wherein the system is a symmetric multiprocessing system.

10. The system of claim 8, wherein the task scheduler receives a further instruction to remove the reservation of the processor, and wherein the task scheduler further modifies the global variable to indicate that the selected processor is not reserved.

11. The system of claim 10, wherein, after receiving the further instruction, the task scheduler allocates subsequent tasks to the selected processor regardless of whether subsequent the tasks have affinity for the selected processor.

12. A method, comprising:
receiving an instruction to reserve a processor of a system including a plurality of processors;
receiving an instruction to perform a task;
determining whether the task has affinity for the reserved processor;
executing the task using the reserved processor, if the task has affinity for the reserved processor; and
executing the task using one of the processors other than the reserved processor, if the task does not have affinity for the reserved processor.

13. The method of claim 12, wherein the system is a symmetric multiprocessing system.

14. The method of claim 12, further comprising:
modifying a global variable indicating that the reserved processor has been reserved.

15. The method of claim 12, wherein the instruction is received at runtime.

16. The method of claim 12, further comprising:
receiving, at runtime, a further instruction to remove the reservation of the processor; and
executing a further task using the formerly reserved processor, after receiving the further instruction, regardless of whether the task has affinity for the reserved processor.

17. The method of claim 16, wherein the further instruction is received at runtime.

18. The method of claim 16, further comprising:
modifying a global variable to indicate that the processor has been unreserved.
